(19) United States
(12) Patent Application Publication
(10) Pub. No.: US 2010/0003027 A1
(43) Pub. Date: Jan. 7, 2010

(54) METHOD AND APPARATUS FOR SUPPORTING STANDBY CHANNELS AND STANDBY BUFFERING

(75) Inventor: Marc R. Bernard, Miramar, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: TELLABS VIENNA, INC., Naperville, IL (US)

(21) Appl. No.: 12/165,866

(22) Filed: Jul. 1, 2008

(51) Int. Cl. H04B 10/08

(52) U.S. Cl. 398/5

(57) ABSTRACT

Providing a user service may be threatened due to an inability to communicate upstream in an event of a network or network node fault. Often the user service is simply terminated leaving a user with a poor perception of the provided user service. In contrast, providing a network service, such as an alternative to the terminated user service, may leave the user with a better perception of the provided user service. Accordingly, a method and corresponding apparatus are provided to support a network service by monitoring states of an access network interface and user network interface of an access network device, and providing a predetermined non-requested channel to the access network device based on a combination of the monitored states. As a result, a service provider can more reliably provide a user service to a user.

### BACKGROUND OF THE INVENTION

In a passive optical network (PON), an optical network terminal (ONT) may be unable to communicate upstream because, for example, the ONT is un-ranged. The ONT, however, may still be able monitor, and thus, receive downstream communications, such as those communicated using an asynchronous transport mode (ATM) virtual channel connection (VCC) or a Gigibit-capable passive optical network (G-PON) encapsulation mode (GEM) port. In some instances, an ONT may even be able to monitor downstream communications communicated using multicast unencrypted GEM Ports (or similar).

### SUMMARY OF THE INVENTION

Example embodiments of the present invention may be implemented in the form of a method or corresponding apparatus that supports network services. A method and corresponding apparatus according to one embodiment of the present invention includes monitoring a state of an access network interface of an access network device and monitoring a state of a user network interface of the access network device. The embodiment provides a predetermined non-requested channel to the access network device based on a combination of the states monitored. The predetermined non-requested channel provided supports network services provided by the access network device.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a network diagram of an example network in which example embodiments of the present invention may be deployed;

FIG. 2 is a network diagram of an example access network device providing network services supported by example embodiments of the present invention;

FIG. 3 is a network diagram of a state of a user service provided through a user network interface being monitored in accordance with embodiments of the present invention;

FIG. 4 is a network diagram of a request being buffered in accordance with an embodiment of the present invention;

FIG. 5 is a network diagram of a state of upstream communication through a passive optical network (PON) interface being monitored in accordance with embodiments of the present invention;

FIG. 6 is a network diagram of a predetermined non-requested channel being provided in accordance with an embodiment of the present invention;

FIG. 7 is a flow chart of an example process for supporting network services, in accordance with an embodiment of the present invention

FIG. 8 is a flow chart of another example process for supporting network services, in accordance with an embodiment of the present invention; and

FIG. 9 is a block diagram of an example apparatus to support network services, in accordance with an embodiment of the present invention.

### DETAILED DESCRIPTION OF THE INVENTION

A description of example embodiments of the invention follows.

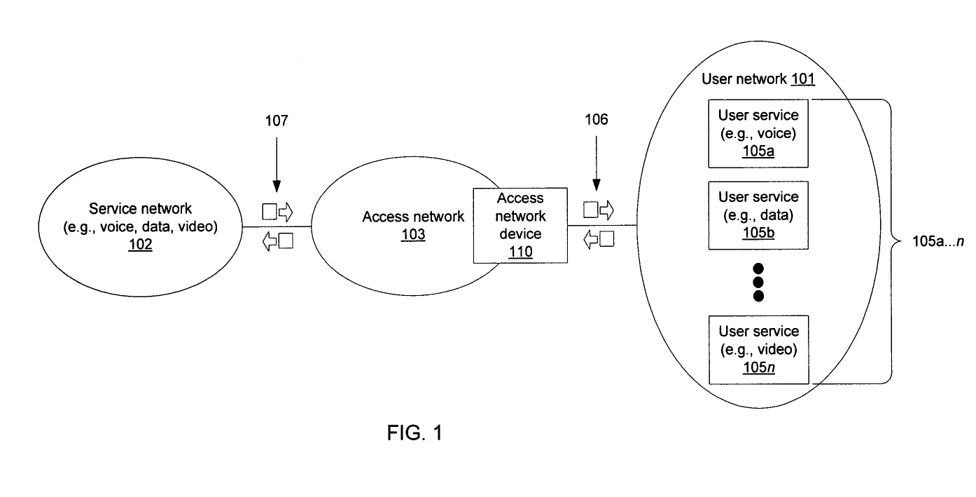

FIG. 1 illustrates a user network 101 and a service network 102 internetworked by an access network 103. The user network 101, for example a home local area network (LAN), has one or more user services 105a, 105b . . . 105n, collectively 105a-n. Generally, the user services 105a-n are services used by a user, such as a voice-based service, data-based service, video-based service, femtocell-based service, or combinations thereof. Specifically, the user services 105a-n may be applications running on or otherwise being executed by a user device, such as a computer, telephone, or set-top box (not shown).

The service network 102 provides the services used by the user. For example, the service network has one or more servers providing hypertext transfer protocol (HTTP) content or other data services, or providing Internet protocol television (IPTV) content or other video services. Other services provided include, for example, voice phone call, voicemail call, data channel-website request, data channel-audio request, data channel-video request, IPTV/channel from set-top box (STB)-audio request, IPTV/channel from STB-video request, cell-phone request-audio, and cell-phone request-data or video.

The access network 103, such as a passive optical network (PON), provides the user network 101, and devices and services therein, such as the user services 105a-n (assumed throughout), and the access network 103, and devices and services therein (assumed throughout), with access to one another. The user network 101 is accessed via the access network 103 in the sense that service messages 106 and the like are communicated to and from the user network 101 through the access network 103. Similarly, the service network 102 is accessed via the access network 103 as service messages 107 and the like which are communicated to and from the service network 102 through the access network 103.

FIG. 1 further illustrates the user network 101 and the access network 103 networked together by an access network device 110. The access network device 110 provides network connectivity for communicating service messages 106 to and from the user network 101.

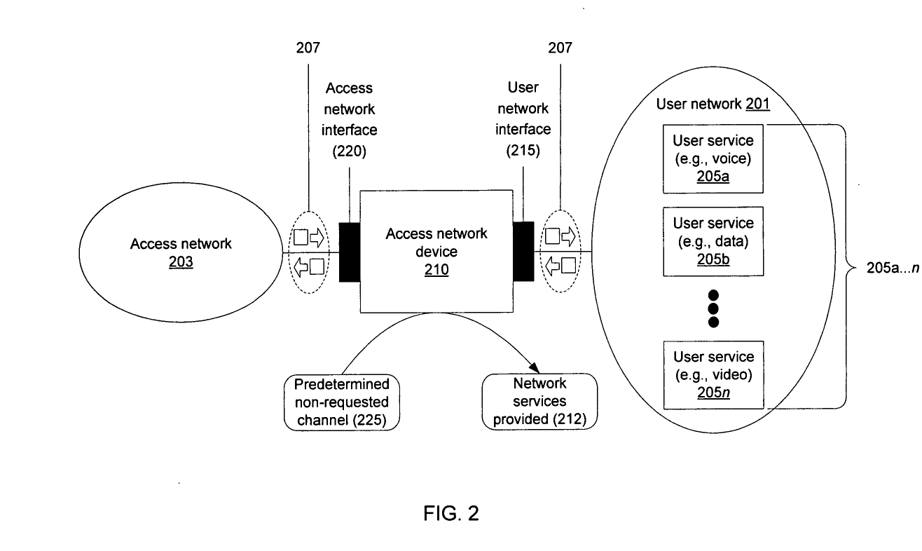

FIG. 2 illustrates in greater detail a user network 201 (with one or more user services 205a, 205b . . . 205n, generally 205a-n) and an access network 203 networked together by an access network device 210 through a user network interface 215 and an access network interface 220 of the access network device 210.

The user network interface 215 is adapted or otherwise configured to network or connect the access network device 210 to the user network 201 (and devices and services therein). For example, where the user network 201 is an ETHERNET network, the user network interface 215 is an ETHERNET interface.

Similarly, the access network interface 220 is adapted to network the access network device 210 to the access network 203 (and devices and services therein). For example, where the access network 203 is a passive optical network (PON), the access network interface 220 is a PON interface.

While described in reference to the physical and data link layers of the Open Systems Interconnection Basic Reference Model (OSI Reference Model), i.e., layers 1 and 2, the access network device 210 may employ additional layers to internetwork the user network 201 and the access network 203 through the user network interface 215 and the access network interface 220.

FIG. 2 further illustrates services being provided by a service network (not shown) to the user network 201, via the access network 203 and the access network device 210, as service messages 206. As illustrated, the service messages 206 represent a service involving bidirectional communications, e.g., sending and receiving service request and service response messages. Other services involve unidirectional communications, and, as such, the service messages 206 may be illustrated differently. In addition to the services provided by the service network, the access network device 210 provides network services 212 to the user network 201.

One embodiment supports the network services 212 provided by the access network device 210 by: monitoring a state of the access network interface 220 of the access network device 210 and monitoring a state of the user network interface 215 of the access network device 210. The embodiment provides a predetermined non-requested channel 225 to the access network device 210 based on a combination of the states monitored.

As described in greater detail below, embodiments of the present invention contemplate more than just active and inactive states of a user network interface and an access network interface. Features of these embodiment and other embodiments are further described and explained in reference to a passive optical network (PON).

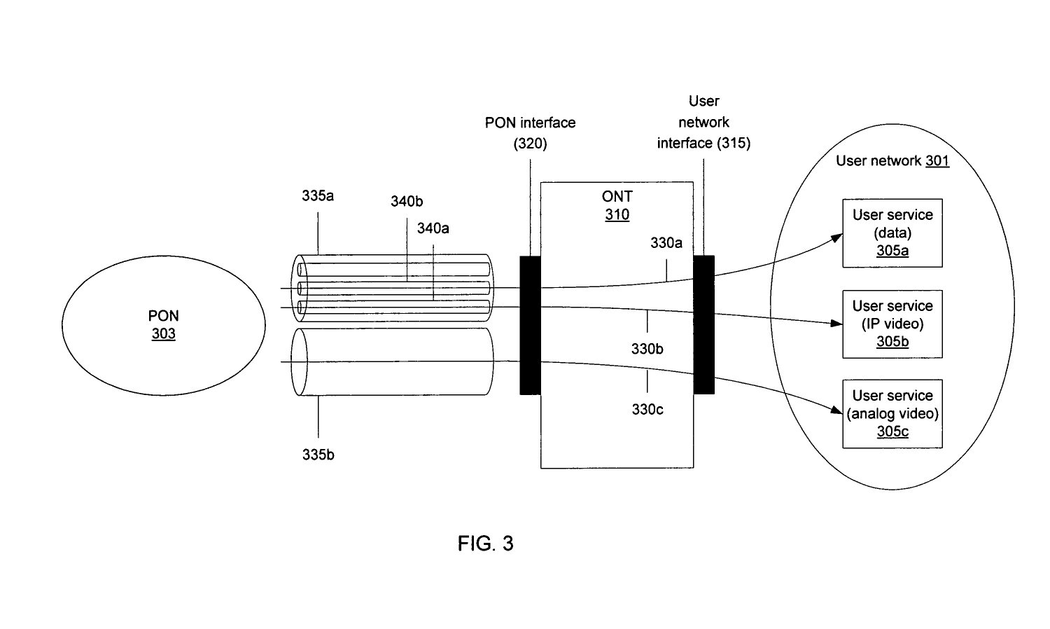

FIG. 3 illustrates services being provided by a service network (not shown) to the user network 301, via an example passive optical network (PON) 303 and an optical network terminal (ONT) 310 with a user network interface 315 and PON interface 320. Services, such as data service 330a and IP video service 330b, are provided over downstream communications 335a using one or more downstream communications paths 340a, 340b.

The data service 330a and the IP video service 330b each use a different, respective, downstream communications path 340a, 340b to provide service to the user network 201 and user services 305a and 305b therein. For example, the user service 305a is provided with data service 330a over the downstream communications path 340a. In another example, the user service 305b is provided with IP video service 330b over the downstream communications path 340b.

At least one of the downstream communications paths 340a, 340b (e.g., the downstream communications path 340a for the data service 330a) may be, for example, an asynchronous transport mode (ATM) virtual channel connection (VCC) or a Gigibit-capable passive optical network (G-PON) encapsulation mode (GEM) port, in accordance with International Telecommunication Union (ITU) specification G.984.3, “Gigibit-capable Passive Optical networks (G-PON): Transmission convergence layer specification,” section 5.3.

Some services, such as analog video service, are provided over separate downstream communications 335b without having to specify paths in the communications themselves. For example, the user service 305c is provided with analog video service 330c over the separate downstream communications 335b.

A convenient embodiment monitors a state of the user network interface 315 by monitoring a state of the services 330a-c provided through the user network interface 315. For example, the embodiment monitoring the state of the services 330a-c, detects the user service 305a being provided with the data service 330a, and identifies the type of service being provided as data. Having monitored the services 330a-c through the user network interface 315, the embodiment is aware that the user service 305a is being provided with the data service 330a and the service being provided is of type data.

A predetermined non-requested channel provided to an access network device, such as the ONT 310, to support network services provided by the access network device is based, in part, on the type of service provided through a user network interface of the access network device, such as the user network interface 315. Continuing with the foregoing example, having monitored the user service 305a being provided with the data service 330a, the embodiment provides a data-based notification, such as a web page to the ONT 310, to support a network service provided by the ONT 310.

In another example, the embodiment monitoring the state of the services 330a-c detects the user service 305b being provided with the IP video service 330b and identifies the type of service being provided as video. Having monitored the services 330a-c through the user network interface 315, the embodiment is aware that the user service 305b is being provided with the IP video service 330b and the service being provided is of type video. The embodiment provides a video-based notification, such as an IPTV channel, to support a network service provided by the ONT 310.

The above examples further illustrate an embodiment providing a predetermined non-requested channel by formatting the predetermined non-requested channel into a format of a user service being provided through the user network interface. In this embodiment, a predetermined non-requested channel in a PON (or other) format may be formatted or otherwise converted into one or more service interface formats. Using the above examples, an embodiment provides a predetermined non-requested channel as a data-formatted notification, IP video-formatted notification, or combination thereof, based on monitoring the user service 305a being provided with the data service 330a or monitoring the user service 305b being provided with the IP video service 330b.

Described earlier, some services involve both upstream and downstream or otherwise bidirectional communications. For example, in IP video service, to watch an IP video channel or to change from a first IP video channel to a second IP video channel, a user service communicates “join” and “leave” signals or messages upstream to a service network providing the IP video service.

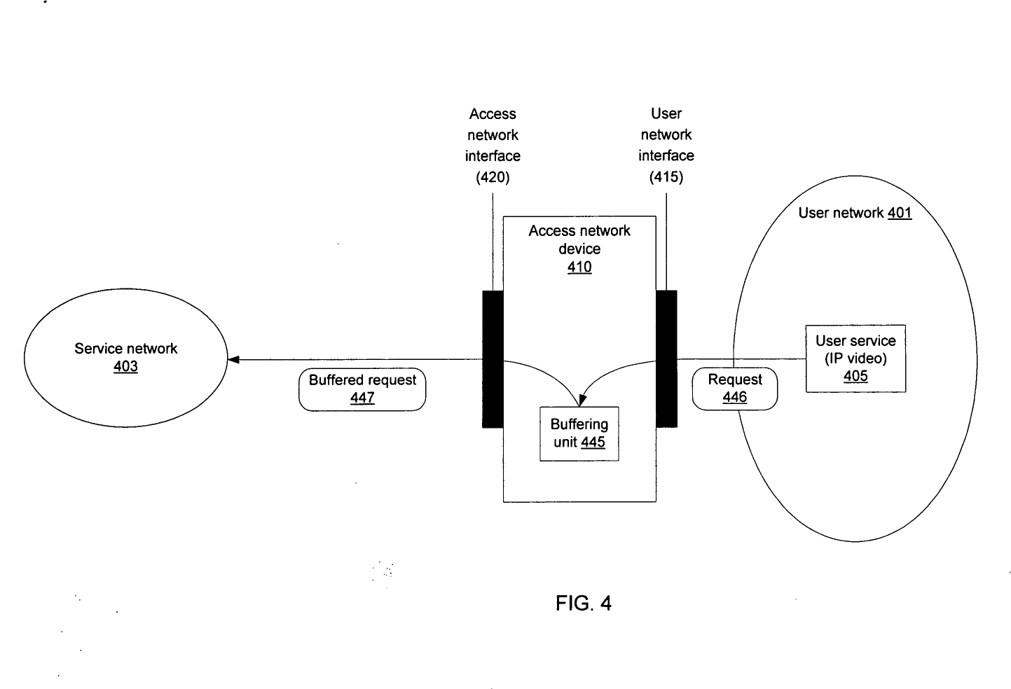

FIG. 4 illustrates an embodiment monitoring a state of a user network interface 415 by buffering a request 446 (e.g., a “join” message) from a user network 401 and a user service 405 in an event upstream communications via an access network interface 420 are disabled and the request 446 cannot be communicated upstream. FIG. 4 further illustrates the embodiment transmitting or otherwise communicating a buffered request 447 upstream to the service network 403 via the access network interface 420 in an event upstream communications are subsequently enabled. As illustrated, an access network device 410 has a buffering unit 445 to buffer the request 446. One skilled in the art will readily recognize, however, the foregoing embodiment does not depend on the access network device 410 and the buffering unit 445 being co-located.

In a convenient embodiment, an ONT receives a request to activate a user service (e.g., voice, data, or video). The ONT is un-ranged and buffers the request. While waiting to be ranged, the ONT provides a predetermined non-requested channel or “standby channel” to a user network interface of the ONT. If the buffered request expires (i.e., the request is not communicated upstream within a time period), the ONT deletes the buffered request. The ONT in this embodiment receives a request from a user network interface and buffers the request, while providing a standby channel, and further waiting for normal conditions to return (i.e., after the ONT is ranged).

Alluded to by the above IP video service example, in some instances, the lack of upstream communications or an inability to communicate upstream adversely affects the service provided. In another example, without upstream communications from a user service, a downstream communications path (e.g., the downstream communications path 340a of FIG. 3) for providing a service is no longer available for use, and the service provided ends.

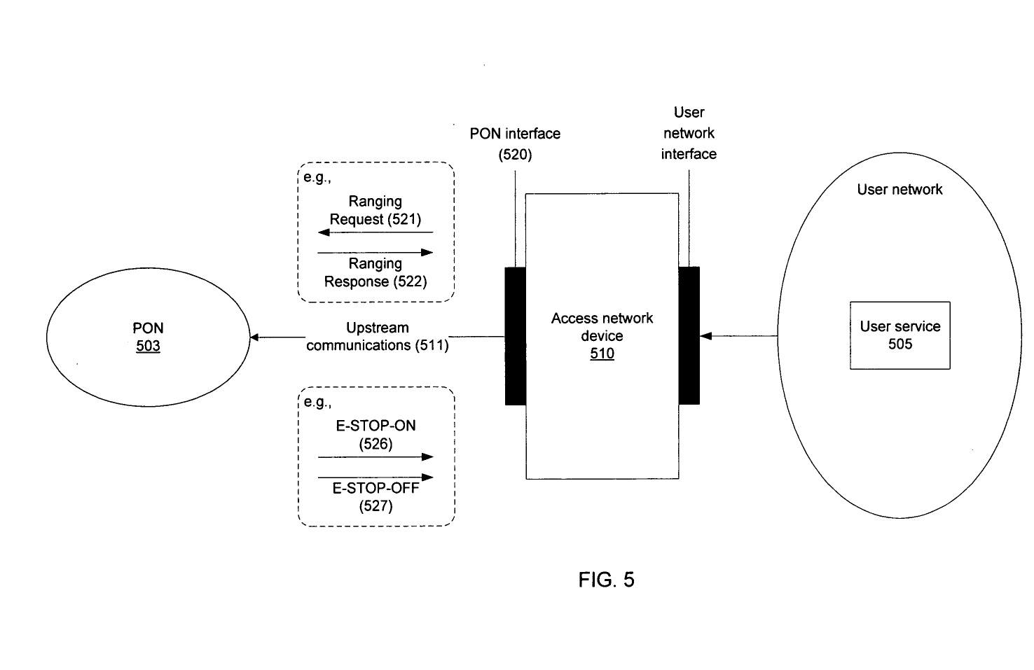

FIG. 5 illustrates an embodiment monitoring a state of upstream communications through a passive optical network (PON) interface 520 of an optical network terminal (ONT) 510. In a PON 503, the ONT 510 communicates upstream communications 511 using time division multiple access (TDMA). TDMA allocates a time slot for each ONT or user to communicate upstream, allowing multiple ONTs to share the same transmission medium while using only a part of the capacity of the transmission medium.

In the PON 503, the ONT 510 is ranged (e.g., in accordance with the International Telecommunication Union (ITU) ITU-T G.983.1 standard) to ensure upstream communications arrive upstream in a time slot allocated to the ONT 510. The ONT 510 may be ranged more than once (e.g., at initialization and during operation) to compensate or otherwise account for variations, such as fiber length. An un-ranged ONT or an ONT that otherwise becomes un-ranged cannot communicate upstream. Upstream communications from such an ONT does not arrive upstream in the correct timeslot, potentially colliding with other upstream communications in a PON.

Continuing with FIG. 5, an embodiment monitors the state of upstream communications of the PON interface 520 by monitoring a ranged state of the PON interface 520 of the ONT 510. For example, the embodiment monitoring the ranged state of the PON interface 520 detects a range request or grant 521, normally received as part of a ranging process, is not received. Having monitored the ranged state as being un-ranged, the embodiment is aware the upstream communications 511 are no longer possible and a user service 505 is adversely affected.

In the foregoing embodiment, a predetermined non-requested channel (not shown, described below in greater detail) provided to the ONT 510 to support network services provided by the ONT 510 is based, in part, on the monitored ranged state of the PON interface 520. For example, a network service provided by the ONT 510 provides a notification (not shown) indicating the ranged state as un-ranged and a possible reason for the ranged state to be un-ranged. This may be advantageous, especially when contrasted with a user service simply ending without explanation.

There are many reasons for the ranged state of the ONT 510 not to be ranged. Reasons include, for example, to save power, an ONT remains un-ranged when user services are inactive; an ONT detects a transmitter failure; and an ONT has trouble ranging due to the ONT itself (i.e., a local problem), an optical line terminal (OLT) (i.e., a far-end problem) or an optical distribution network (ODN) (i.e., network problem).

In another example, given an un-ranged state, the embodiment monitoring the ranged state of the PON interface 520 detects a ranging response 522, or other message indicating the ONT being ranged. Having monitored the ranged state as being ranged, the embodiment is aware upstream communications are again possible, and the user service 505 may again be provided.

In the PON 503, the ONT 510 may be provisioned or instructed to enter an emergency stop (E-STOP) state. Broadband passive optical network (BPON) standards or gigabit passive optical network (GPON) standards define the E-STOP state as an upstream communications state having an enabled state and disabled state. The upstream communications 511 are enabled if the state of upstream communications is in the enabled state. Conversely, the upstream communications 511 are disabled if the state of upstream communications is in the disabled state.

The E-STOP-ON state provisions or instructs the ONT 510 to go into or otherwise enter the emergency stop state, i.e., the disabled upstream communications state. During the disabled upstream communications state, the ONT 510 does not communicate upstream, but continues to receive and process downstream communications. The E-STOP-OFF state provisions or instructs the ONT to recover or otherwise exit from the emergency stop state and to communicate upstream once again.

Continuing with FIG. 5, an embodiment monitors the state of upstream communications of the PON interface 520 by monitoring an E-STOP state of the PON interface 520 of the ONT 510. For example, the embodiment monitoring the E-STOP state of the PON interface 520 detects and E-STOP-ON message or signal 526 instructing the ONT 510 to enter the emergency stop state (i.e., the disabled upstream communications state). Having monitored the E-STOP state as being E-STOP-ON, the embodiment is aware the upstream communications 511 are no longer possible and the user service 505 is adversely affected.

In the foregoing embodiment, a predetermined non-requested channel provided to the ONT 510, to support network services provided by the ONT 510 is based, in part, on the monitored E-STOP state of the PON interface 520. For example, a network service provided by the ONT 510 provides a notification indicating the E-STOP state as E-STOP-ON. This may be advantageous especially when contrasted with a user service simply ending without explanation.

In another example, given an E-STOP-ON state (i.e., disabled upstream communications state), the embodiment monitoring the E-STOP state of the PON interface detects an E-STOP-OFF message or signal 527 instructing the ONT to recover from the emergency stop state. Having monitored the E-STOP state as being E-STOP-OFF, the embodiment is aware the upstream communications 511 are again possible and user services may again be provided.

The foregoing describes example embodiments monitoring a state of an access network interface of an access network device and monitoring a state of a user network interface of the access network device to support network services provided by the access network device.

Now described in reference to a passive optical network (PON) and referring to Table 1 below, an embodiment provides, based on a combination of a state of a PON interface (column 1 of Table 1) and the state of the user network interface (column 2 of Table 1)—as monitored according to previously described example embodiments—a predetermined non-requested channel (column 3 of Table 1) to an ONT to support network services provided by the ONT.

TABLE 1

| | | Relay the following |
|---|---|---|
| | | PON channel or Multicast |
| General ONT condition | Service | IP Address or similar. |
| ONT unranged due to low-power | Voice | Audio channel A |
| mode | Data | Data channel B |
| | Video | Video channel C |
| ONT in E-STOP mode | Voice | Audio channel D |
| | Data | Data channel E |
| | Video | Video channel F |
| ONT Transmitter in a failure mode | Voice | Audio channel G |
| | Data | Data channel H |
| | Video | Video channel I |
| PON card in a failure mode | Voice | Audio channel J |
| | Data | Data channel K |
| | Video | Video channel L |
| Etc | Etc | Etc |

Consider the following example. The embodiment monitors the state of the PON interface on the ONT as “ONT in E-STOP mode,” for example, by detecting an E-STOP-ON. The embodiment monitors the state of the user network interface of the ONT as “voice,” for example, by detecting voice traffic.

Based on the “ONT in E-STOP mode,” monitored state of the PON interface and the “voice,” monitored state of the user network interface, the embodiment provides an “Audio Channel D,” predetermined non-requested channel to the ONT to support network services provided by the ONT. The “Audio Channel D,” is a predetermined channel because the channel (and its content) is set or otherwise determined prior to the channel being provided (i.e., before a disruption). The “Audio Channel D,” is a non-requested channel because a user service does not request the channel (and its contents).

As noted previously, the format of the predetermined non-requested channel provided may be in a format of the user service provided by the user network interface. In this example, because the monitored state of the user network interface is “voice,” the embodiment provides “Audio Channel D,” as an audio-formatted predetermined non-requested channel.

Also noted previously, the predetermined non-requested channel provided may include or present a reason. In this example, the “Audio Channel D,” predetermined non-requested channel announces “ONT in E-STOP mode,” as the reason for the disruption.

One skilled in the art will readily recognize that the predetermined non-requested channel provided is not limited to presenting a reason, but may present any suitable content. For example, the predetermined non-requested channel presents an advertisement, news article, movie preview, etc. Presenting these and other alternative content in a predetermined non-requested channel provided may be advantageous, especially when contrasted with presenting no content at all.

One embodiment provides a predetermined non-requested channel by relaying a channel sent downstream to an access network device. In this embodiment, an entity (or a process running on the entity) other than the access network device is the source of the predetermined non-requested channel provided.

Another embodiment provides a predetermined non-requested channel by outputting a channel sourced by an access network device. In this embodiment, the access network device is the source of the predetermined non-requested channel provided.

A profile, such as Table 1, may be configured and provided by a service provider. Given such a profile, an embodiment accesses the profile or database of possible states of an access network interface and a user network interface, and retrieves a result of such access indicating a predetermined non-requested channel. The embodiment applies the result retrieved to provide the predetermined non-requested channel to an access network device.

The profile may include additional parameters such as length of time, multiple channel options, channel type information (insert language from disclosure). Further, the profile may include an attribute that indicates if service should automatically be switched over to “normal” service if an access network device becomes “normal” after a disruption. For example, one embodiment, after transitioning from providing a requested channel to providing a predetermined non-requested channel, reverts from providing the predetermined non-requested channel to providing the requested channel based on a combination of states of the access network interface and user network interface.

Consider the following example. The embodiment having monitored a state of a PON interface as “ONT in E-STOP mode,” and having monitored a state of a user network interface as “video,” now monitors the state of the PON interface as “normal,” e.g., by detecting an E-STOP-OFF and the state of the user network interface as “video.” The embodiment reverts from providing a “Video Channel F,” predetermined non-requested channel to an ONT to providing a requested channel (e.g., an IP video channel watched prior to a disruption).

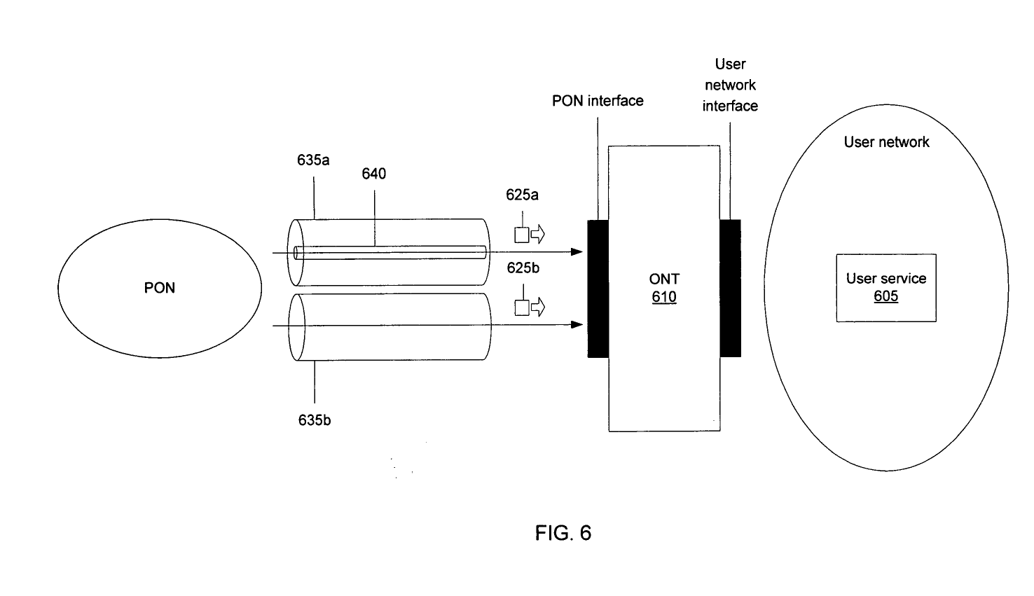

FIG. 6 illustrates an embodiment providing a predetermined non-requested channel 625a to an ONT 610 using a downstream communications path 640 normally used for providing channels other than the predetermined non-requested channel. Described previously, a service is provided to a user service 605 over downstream communications 635a using one or more downstream communications paths. Some downstream communications paths are available for use only if an ONT is ranged and communicating upstream (e.g., requesting a service be provided downstream using a downstream communications path). Other downstream communications paths are available for use even if an ONT is un-ranged or otherwise unable to communicate upstream. The latter may used to communicate, for example, an unscrambled IPTV channel downstream.

FIG. 6 illustrates the downstream communications path 640 as a downstream communications path that may be detected or otherwise used for providing services when the ONT 610 is un-ranged. The predetermined non-requested channel 625a instead of, for example, an unscrambled IPTV channel, is now provided to the ONT 610 using the downstream communications path 640.

The downstream communications path 640 may be, for example, an asynchronous transport mode (ATM) virtual channel connection (VCC) or a Gigibit-capable passive optical network (G-PON) encapsulation mode (GEM) port, in accordance with International Telecommunication Union (ITU) specification G.984.3, “Gigibit-capable Passive Optical networks (G-PON): Transmission convergence layer specification,” section 5.3.

As noted earlier, some services, such as analog video service, are provided over separate downstream communications 635b without having to specify paths in the communications themselves. In this case, the embodiment provides a predetermined non-requested channel 625b to the ONT 610 using the separate downstream communications 635b. The predetermined non-requested channel 625b instead of, for example, analog channels is now provided to the ONT 610 using the separate downstream communications 635b.

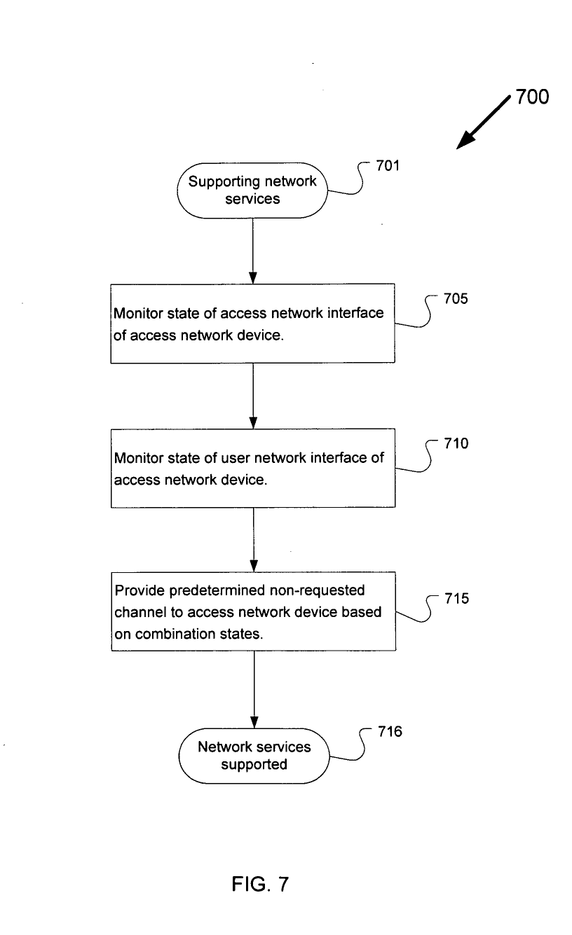

FIG. 7 illustrates an example process of 700 for supporting network services. The process 700 starts (701). The process 700 monitors (705) a state of an access network interface of an access network device. The process 700 monitors (710) a state of a user network interface of the access network device. The process 700 provides (715) a predetermined non-requested channel to the access network device based on a combination of states. The process 700 ends (716) with network services supported.

In another embodiment, a process (not shown) further identifies a predetermined non-requested channel is being or has been provided to the user network interface and transmits a notification in an upstream direction to an end user or management node, such as an element management system (EMS).

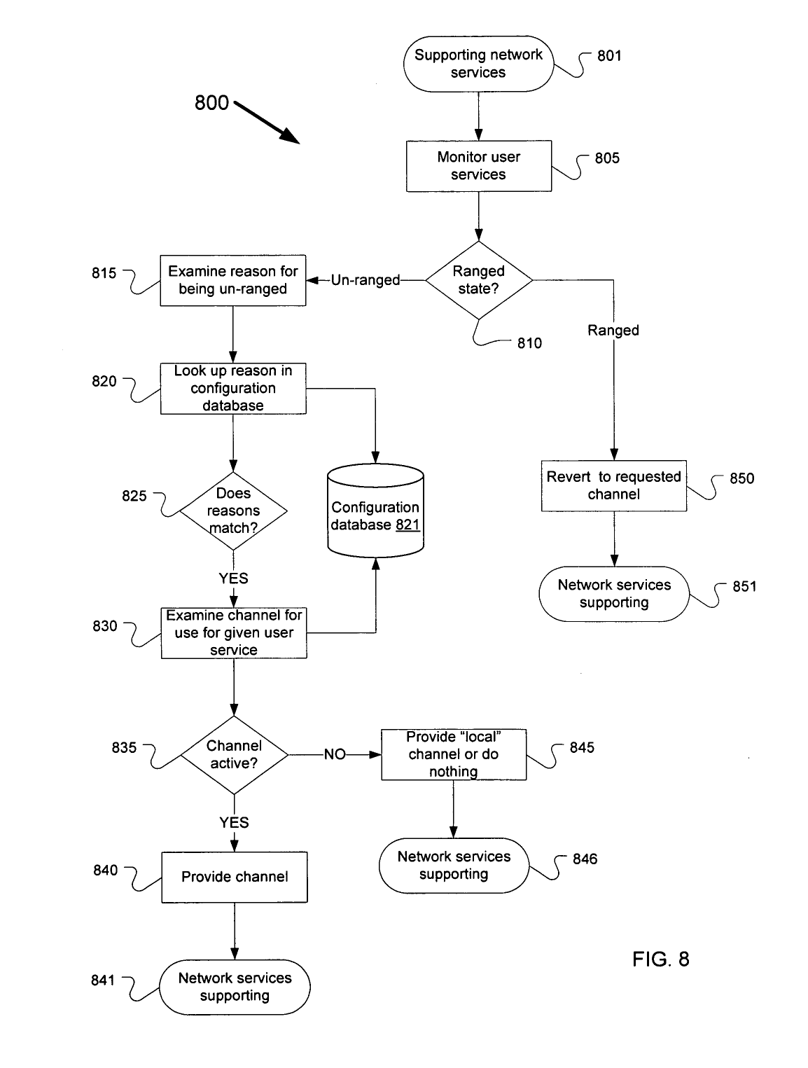

FIG. 8 illustrates another example process 800 for supporting network services. The process 800 monitors (805) a state of user services provided through a user network interface of an ONT. If the monitored state of the user services provided is active, the process 800 determines (810) whether a ranged state of a PON interface of the ONT is ranged or un-ranged; else, the process 800 continues to monitor (805) the state of the user service provided.

If the process 800 determines (810) that the ranged state of the PON interface is un-ranged, the process 800 examines (815) a reason for being un-ranged and looks up (820) the reason in a configuration database 821.

The process 800 determines (825) whether the reason examined in 815 matches the reason looked up in 820. If the reasons match, the process 800 looks up (830) a channel for a given user service in the configuration database 821.

The process 800 determines (835) whether the channel looked up in 830 is active in PON or other network, such as a service network.

If the process 800 determines (835) that the channel is active, the process 800 then provides (840) the channel as a predetermined non-requested channel or “standby channel” to the ONT, and the process 800 ends (841) with the network services supported.

If, however, the process 800 determines (835) that the channel is not active, the process 800 provides (845) a channel “local” to the process 800 (e.g., from the ONT) or alternatively does nothing, and the process 800 ends (846) with the network services supported.

Returning to the process 800, the process 800 determines (810) whether the ranged state of the PON interface of the ONT is ranged. If the ranged state of the PON interface is ranged, the process 800 reverts (850) from providing the predetermined non-requested channel (provided in 840) to providing a requested channel. In one embodiment (not shown), a process determines whether a predetermined non-requested channel or “standby channel” is active or otherwise being provided. If the process determines that the standby channel is being provided, the process stops providing the standby channel. The process then transfers a user service from the standby channel to an actual channel (e.g., a channel previously watched) and performs regular functions. Continuing with the previous embodiment, the process 800 ends (851) with the network services supported.

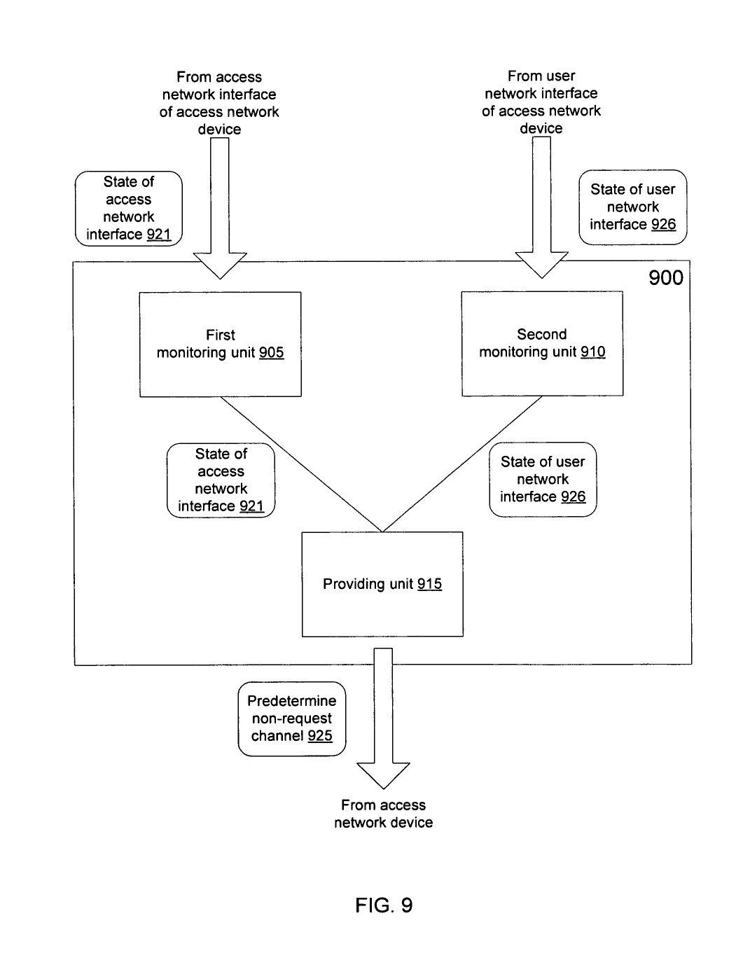

FIG. 9 illustrates an example apparatus 900 to support network services. The apparatus 900 has a first monitoring unit 905 and a second monitoring unit 910 each communicatively coupled to a providing unit 915. The first monitoring unit 905 is configured or otherwise adapted to monitor a state of an access network interface 921 of an access network device (not shown). The second monitoring unit is configured to monitor a state of a user network interface 926 of the access network device. The providing unit 915 is configured to provide, based on the state of the access network interface 921 and the state of the user network interface number 926 monitored, a predetermined non-requested channel 925 to the access network device.

While this invention has been particularly shown and described with references to example embodiments thereof, it will be understood by those skilled in the art that various changes in form and details may be made therein without departing from the scope of the invention encompassed by the appended claims.

It should be understood that the block, flow, and network diagrams may include more or fewer elements, be arranged differently, or be represented differently. It should be understood that implementation may dictate the block, flow, and network diagrams and the number of block, flow, and network diagrams illustrating the execution of embodiments of the invention.

It should be understood that elements of the block, flow, and network diagrams described above may be implemented in software, hardware, or firmware. In addition, the elements of the block, flow, and network diagrams described above may be combined or divided in any manner in software, hardware, or firmware. If implemented in software, the software may be written in any language that can support the embodiments disclosed herein. The software may be stored on any form of computer readable medium, such as random access memory (RAM), read only memory (ROM), compact disk read only memory (CD-ROM), and so forth. In operation, a general purpose or application specific processor loads and executes the software in a manner well understood in the art.

What is claimed is:

1. A method for supporting network services comprising:
monitoring a state of an access network interface of an access network device;
monitoring a state of a user network interface of the access network device; and
providing a predetermined non-requested channel to the access network device based on a combination of the states to support network services provided by the access network device.

2. The method of claim 1 wherein the access network device is an optical network terminal (ONT) and the access network interface is a passive optical network (PON) interface, wherein monitoring the state of the access network interface includes monitoring a state of upstream communications through the PON interface, and wherein providing the predetermined non-requested channel includes providing the predetermined non-requested channel to the ONT using a downstream communications path normally used for providing channels other than the predetermined non-requested channel.

3. The method of claim 2 wherein monitoring the state of upstream communications includes monitoring a ranged state of the PON interface.

4. The method of claim 2 wherein monitoring the state of upstream communications includes monitoring an E-STOP state of the PON interface.

5. The method of claim 1 wherein monitoring the state of the user network interface includes monitoring a state of user services provided through the user network interface.

6. The method of claim 1 wherein monitoring the state of the user network interface includes:
buffering a request, received by the user network interface, in an event upstream communications via the access network interface are disabled; and
transmitting the request buffered upstream via the access network interface in an event upstream communications are subsequently enabled.

7. The method of claim 1 wherein providing the predetermined non-requested channel includes relaying a channel sent downstream to the access network device.

8. The method of claim 1 wherein providing the predetermined non-requested channel includes outputting a channel sourced by the access network device.

9. The method of claim 1 wherein providing the predetermined non-requested channel includes formatting the predetermined non-requested channel into a format of a user service being provided through the user network interface.

10. The method of claim 1 wherein providing the predetermined non-requested channel includes:
accessing a database of possible states of the access network interface and the user network interface;
retrieving a result of the accessing indicating a predetermined non-requested channel; and
applying the result retrieved to provide the predetermined non-requested channel to the access network device.

11. The method of claim 1 wherein providing the pre-determined non-requested channel includes transitioning from providing a requested channel to providing the predetermined non-requested channel and further comprising reverting from providing the predetermined non-requested channel to providing the requested channel based on a combination of states of the access network interface and user network interface.

12. The method of claim 1 further comprising:
identifying a predetermined non-requested channel is being or has been provided to the user network interface; and
transmitting a notification in an upstream direction to an end user or management node.

13. An apparatus to support network services comprising:
a first monitoring unit to monitor a state of an access network interface of an access network device;
a second monitoring unit communicatively coupled to the first monitoring unit to monitor a state of a user network interface of the access network device; and
a providing unit communicatively coupled to the first monitoring unit and the second monitoring unit to provide a predetermined non-requested channel to the access network device based on a combination of the states to support network services provided by the access network device.

14. The apparatus of claim 13 wherein the access network device is an optical network terminal (ONT) and the access network interface is a passive optical network (PON) interface, wherein the first monitoring unit is configured to monitor a state of upstream communications through the PON interface, and wherein the providing unit is configured to provide the predetermined non-requested channel to the ONT using a downstream communications path normally used for providing channels other than the predetermined non-requested channel.

15. The apparatus of claim 14 wherein the first monitoring unit is configured to monitor a ranged state of the PON interface.

16. The apparatus of claim 14 wherein the first monitoring unit is configured to monitor an E-STOP state of the PON interface.

17. The apparatus of claim 13 wherein the second monitoring unit is configured to monitor a state of user services provided through the user network interface.

18. The apparatus of claim 13 wherein the second monitoring unit includes:
a buffering unit to buffer a request, received by the user network interface, in an event upstream communications via the access network interface are disabled; and
a transmitting unit communicatively coupled to the buffering unit to transmit the request buffered upstream via the access network interface in an event upstream communications are subsequently enabled.

19. The apparatus of claim 13 wherein the providing unit is configured to relay a channel sent downstream to the access network device.

20. The apparatus of claim 13 wherein the providing unit is configured to output a channel sourced by the access network device.

21. The apparatus of claim 13 wherein the providing unit is configured to format the predetermined non-requested channel into a format of a user service being provided through the user network interface.

22. The apparatus of claim 13 wherein the providing unit includes:
an accessing unit to access a database of possible states of the access network interface and the user network interface;
a retrieving unit communicatively coupled to the accessing unit to retrieve a result from the accessing unit indicating a predetermined non-requested channel; and
an applying unit communicatively coupled to the retrieving unit to apply the result retrieved to provide the predetermined non-requested channel to the access network device.

23. The apparatus of claim 13 wherein the providing unit is configured to transition from providing a requested channel to providing the predetermined non-requested channel and is further configured to revert from providing the predetermined non-requested channel to providing the requested channel based on a combination of states of the access network interface and user network interface.

24. The apparatus of claim 13 further comprising:
an identifying unit to identify a predetermined non-requested channel is being or has been provided to the user network interface; and
a transmitting unit communicatively coupled to the identifying unit to transmit a notification in an upstream direction to an end user or management node.

25. A computer program product including a computer readable medium having a computer readable program, the computer readable program, when executed by a computer causes the computer to:
monitor a state of an access network interface of an access network device;
monitor a state of a user network interface of the access network device; and
provide a predetermined non-requested channel to the access network device based on a combination of the states to support network services provided by the access network device.
